(19) United States
(12) Patent Application Publication
(10) Pub. No.: US 2007/0116076 A1
(43) Pub. Date: May 24, 2007

(54) Controlling optical power and extincation ratio of a semiconductor laser

(76) Inventors: Frank Wang, Sunnyvale, CA (US); Chien-Chang Liu, Sunnyvale, CA (US); HengJu Cheng, Mountain View, CA (US); Lee Xu, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/284,755

(22) Filed: Nov. 21, 2005

(51) Int. Cl. H01S 3/00

(52) U.S. Cl. 372/38.07; 372/38.01

(57) ABSTRACT

Disclosed herein are methods, apparatus, and systems to achieve substantially constant optical power and/or extinction ratio for a semiconductor laser. In one aspect, a microcontroller of an optical transmitter may adjust an electrical current that is provided to a semiconductor laser based at least in part on a comparison of a first measured optical power of light emitted by the semiconductor laser and a predetermined target optical power. The microcontroller may then determine an electrical current that is capable of giving the semiconductor laser a substantially constant extinction ratio by evaluating an equation with the first measured optical power and a second optical power measured after the controller adjusts the electrical current.

### RELATED APPLICATIONS

The present application is related to co-pending U.S. patent application Ser. No. 11/008,905, filed on Dec. 10, 2004.

### BACKGROUND

1. Field

One or more embodiments of the invention relate to the control of semiconductor lasers. In particular, one or more embodiments of the invention relate to the control of optical power and/or extinction ratio of semiconductor lasers.

2. Background Information

Semiconductor lasers are used in a wide variety of applications. In particular, semiconductor lasers are integral components in optical communication systems where a beam modulated with large amounts of information may be communicated great distances at the speed of light over optical fibers as well as short reach distances such as from chip-to-chip in a computing environment.

The semiconductor lasers are commonly operated at different temperatures. One reason for which the temperature of the semiconductor lasers may change is due to heat generation by proximate circuits and other heat generating components. In so-called Small Form Factor (SFF) modules, the change in temperature may be exacerbated due to the close proximity of such components within a relatively small module. Furthermore, multiple SFF modules may be included in the same line card or network device, which may further promote an increase in temperature. Different ambient temperatures may also affect the temperature of the lasers. As a result, optical transceivers are often expected to operate over a relatively wide temperature range, such as, for example, from about as cold as −10° C. to about as hot as +70°, or in some cases an even greater temperature range, such as, for example, from about −40° C. to about +85° C.

A challenge is that certain characteristics of the semiconductor lasers may change with temperature. Several well-known parameters that may change with temperature include threshold current, slope efficiency, and extinction ratio. If unmitigated, changes in one or more of these parameters may significantly diminish performance of optical transceivers in which the semiconductor lasers are employed.

Various approaches for compensating for these changing laser characteristics are known in the arts. In one illustrative approach, a look-up table may be stored in a memory. The look-up table may be used to store a laser driver current that is appropriate to drive the laser at a particular temperature. Potential drawbacks of such an approach are that the provision of the memory to store the look-up table may increase manufacturing cost, and/or that obtaining the data to populate the look-up table may be costly to obtain, difficult to obtain, inconvenient to obtain, and/or inaccurate. Other approaches are based on using automatic power control (APC) loops or thermistors.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a plot showing representative laser output power versus laser input drive current characteristics for a semiconductor laser at two different temperatures, according to one or more embodiments.

FIG. 2 is a block diagram showing pertinent components of an optical transmitter, according to one or more embodiments of the invention.

FIG. 3 is a block flow diagram of a method of adjusting drive currents of a semiconductor laser in order to attempt to maintain a substantially constant optical power and a substantially constant extinction ratio, according to one or more embodiments of the invention.

FIG. 4 is a sectional view of a transmitter optical sub-assembly (TOSA) suitable for one or more embodiments of the invention.

FIG. 5 is a perspective view showing the TO-can for housing an optoelectronic assembly.

FIG. 6 is a block diagram of an optical transceiver suitable for one or more embodiments of the invention.

FIG. 7 is a perspective view of an exemplary Small Form Factor (SFF) optical transceiver package suitable for one or more embodiments of the invention.

FIG. 8 is a block diagram of a network switching equipment including switch fabric and a line card having multiple optical transceivers, according to one or more embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

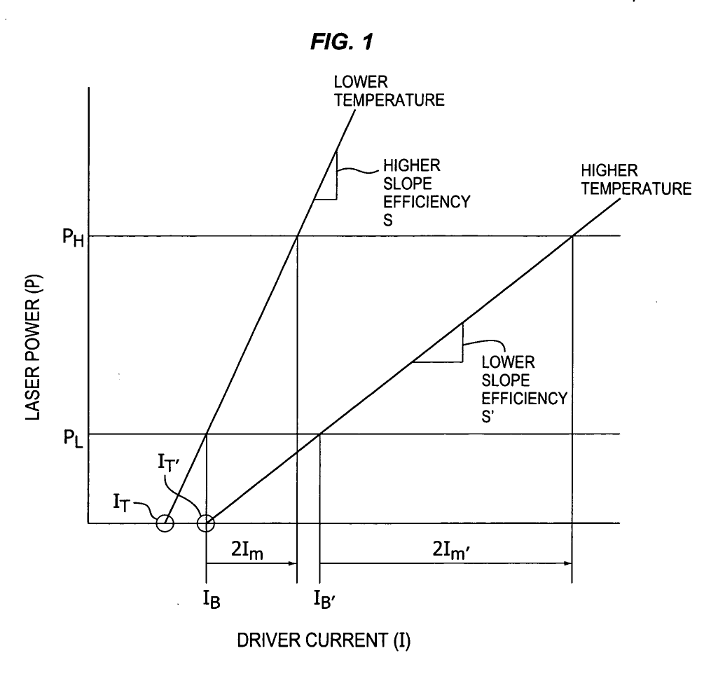

FIG. 1 is a plot showing representative laser output power versus laser input drive current characteristics for a semiconductor laser at two different temperatures, according to one or more embodiments. Vertical cavity surface emitting laser (VCSELs) and Fabry-Perot lasers tend to exhibit similar characteristics. Other types of semiconductor lasers may also have a slope efficiency and/or threshold current that may depend upon temperature.

The plot shows driver current (I) that is provided to the laser on the horizontal axis, and laser output power (P) that corresponds to the driver current on the vertical axis. Two different “curves” are shown, one at a “lower temperature” and one at a “higher temperature”.

The “curves” are characterized by two well-known characteristics, namely the threshold current and the slope efficiency. First threshold current will be discussed, and then slope efficiency will be discussed.

A first threshold current (I_{T}) is labeled on the lower temperature plot, and a second threshold current (I_{T}′) is labeled on the higher temperature plot. Below the threshold currents, laser output increases significantly more slowly with increasing driver current than above the threshold currents. Often, the laser output power below the threshold currents is considered to be negligible. Above the threshold current, the output power may tend to increase substantially linearly with increasing driver current.

As temperature increases, the threshold current tends to increase. Notice that the threshold current at the lower temperature (namely I_{T}) is lower than the threshold current at the higher temperature (namely I_{T}′). Without wishing to be bound by theory, the threshold current may represent the point at which optical gain surpasses optical losses. The increase in the threshold current with increasing temperature may be due to a decrease in the optical gain of the laser with increasing temperature. As the optical gain decreases, more current may be needed to obtain coherent light emission, and this may cause the threshold current to increase. However, the scope of the invention is not limited to any known reason for this effect, inasmuch as the illustrated temperature dependency has been observed in actual practice.

Once the semiconductor laser is biased at a current that is above the threshold current, the output optical power may increase substantially linearly with increasing driver current. The ratio of the change of laser output power per corresponding change of input driver current is known as the slope efficiency. The slope efficiency may represent the slope of the linear portion of the plot above the threshold current.

As shown, the slope efficiency may decrease with increasing temperature. A first slope efficiency (S) is labeled on the lower temperature plot, and a second slope efficiency (S′) is labeled on the higher temperature plot. Notice that the slope efficiency at the lower temperature (namely S) is greater than the slope efficiency at the higher temperature (namely S′).

Semiconductor lasers are often operated in the substantially linear region above the threshold current. The lasers may emit either a low optical power (P_{L}) or a high optical power (P_{H}). P_{H} often corresponds to a digital “1”, and P_{L} often corresponds to a digital “0”. The semiconductor laser may rapidly alternate between emitting low and high optical powers in order to communicate a string of zeroes and ones representing digital information.

In certain cases, a rapidly changing modulation current may be added to a substantially constant bias current in order to cause the laser to emit light at the high optical power, and the modulation current may be subtracted from the bias current in order to cause the laser to emit light at the low optical power. Notice that the driver currents needed to obtain P_{H} and P_{L} at the lower temperature differ by two times a first modulation current (2*Iₘ), and that the driver currents needed to obtain P_{H} and P_{L} at the higher temperature differ by two times a second modulation current (that is 2*Iₘ′). Notice also that Iₘ′ is greater than Iₘ. Since the slope efficiency (S′) at the higher temperature is less than the slope efficiency (S) at the lower temperature, the modulation current (Iₘ′) at the higher temperature needs to be greater than the modulation current at the lower temperature in order to maintain the same P_{H} and P_{L}. Thus a modulation current may be increased to offset a decrease in slope efficiency.

Another well-known laser characteristic that may change with temperature is the extinction ratio. The extinction ratio may represent the ratio of the high output optical power (P_{H}) level of the laser to the low output optical power (P_{L}) level of the laser, namely (P_{H}/P_{L}). In other words, the extinction ratio may represent the ratio of transmitted power for a digital “1” when the laser is “on” to the transmitted power for a digital “0” when the laser is “off”. As clearly seen in FIG. 1, if the slope efficiency decreases and the driver current (for example modulation current) is not correspondingly increased, then the extinction ratio will also decrease. In other words, if the modulation current is not increased from Iₘ to Iₘ ′ in order to offset a decrease in P_{H}, then an increase in temperature from the lower to higher temperatures may cause a significant reduction in the extinction ratio.

A significant decrease in the extinction ratio may adversely affect performance of an optical transceiver. For example, a decrease in the extinction ratio may adversely affect the bit error ratio (BER) and/or the signal-to-noise ratio. In some cases, optical transceivers may be designed to have undesirably large extinction ratios at lower temperatures in order to be capable of meeting specifications, such as, for example, those of Synchronous Optical Network (SONET), at the maximum expected operating temperature. Using such a large extinction ratio may tend to promote other problems, such as, for example, increased jitter and the power.

The discussion above describes the changing characteristics of semiconductor lasers due to changes in temperature. However, the characteristics of semiconductor lasers may also change due to other factors, such as, for example, the age of the laser (for example due to degradation), and/or due to process variation encountered during laser fabrication. Embodiments of the invention may be useful for reducing changes due to all of such causes.

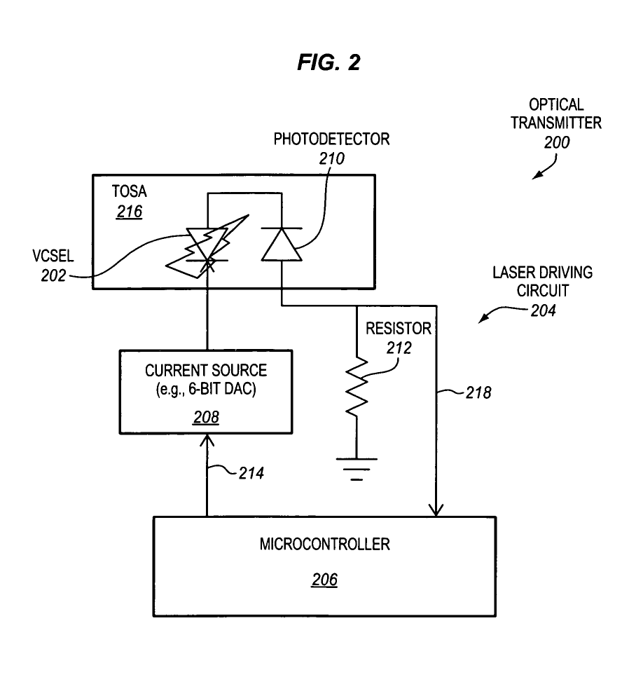

FIG. 2 is a block diagram showing pertinent components of an optical transmitter 200, according to one or more embodiments of the invention. The optical transmitter includes a vertical cavity surface emitting laser (VCSEL) 202, and a laser driving circuit 204 to drive the VCSEL. Alternate embodiments may include other semiconductor lasers besides VCSELs. The particular illustrated laser driving circuit includes a microcontroller 206, a variable current source 208, a photodetector 210, and a resistor 212.

The microcontroller is electrically coupled with, or otherwise in communication with, the current source, such as, for example, by an interconnect 214, such as, for example, a serial interface. The microcontroller may communicate or otherwise provide electrical control signals to the current source in order to control and/or indicate how much electrical current the current source is to provide to the VCSEL. One suitable microcontroller is the ATmega88 general-purpose microcontroller available from Atmel Corporation, of San Jose, Calif., although the scope of the invention is not so limited. Other general-purpose microcontrollers may also optionally be used.

In one or more embodiments of the invention, the variable current source may include a 6-bit digital-to-analog converter (DAC) current source, although the scope of the invention is not limited in this respect. In such embodiments, the microcontroller may provide a 6-bit digital current code signal to the 6-bit DAC current source. The 6-bit digital current code may be capable of coding and indicating 64 different amounts of electrical current. As one example, a value of 111111 may correspond to the highest supported current, and a value of 000000 may correspond to the lowest supported current, although this is just one possible convention. It should be appreciated that the use of a 6-bit current code signal is not required. Other suitable multiple-bit current code signals include, but are not limited to, 4-bit, 5-bit, 7-bit, 8-bit, 9-bit, 10-bit, and 16-bit current code signals.

The 6-bit DAC current source may receive the 6-bit current code signals, or other electrical signals, from the microcontroller. The 6-bit DAC current source may convert the 6-bit current code signal into a corresponding amount of current. Representative DAC current sources are discussed, for example, in U.S. Pat. No. 5,001,484 to Weiss. By way of example, the DAC current source may include an array of current source transistors that produce output currents of weighted values that represent bits in a binary word or code. The current source is electrically coupled with, or otherwise in communication with, the VCSEL, and may provide the amount of electrical current to the VCSEL.

The VCSEL may receive the amount of electrical current from the current source. A vertical cavity surface emitting laser (VCSEL) is one prevalent type of semiconductor micro-laser diode. This type of laser emits a coherent beam of light “vertical” or orthogonal to a surface of a semiconductor substrate having the VCSEL formed therein. The VCSEL represents one suitable type of semiconductor laser, although the scope of the invention is not limited to VCSELs. Other semiconductor lasers, such as, for example, various well-known semiconductor diode lasers, are also suitable. The VCSEL may transmit, emit, or otherwise provide an amount of light that corresponds to the amount of received electrical drive current.

The photodetector is optically coupled with, or otherwise in optical communication with, the VCSEL, and may detect light emitted or otherwise provided by the VCSEL. Representative suitable photodetectors include, but are not limited to, avalanche photodiodes, photomultiplier tubes, p-n photodiodes, p-i-n photodiodes, and the like. As shown in the illustrated embodiment, the VCSEL and the photodetector may optionally be integrated or otherwise included within a common transmitter optical sub-assembly (TOSA) 216, although the scope of the invention is not limited in this respect. Suitable TOSAs having VCSEL integrated with photodetectors are commercially available from EMCORE Corporation of Somerset, N.J., and AOC Technologies, Inc., of Dublin, Calif., although the scope of the invention is not limited to just these TOSA. The photodetector may generate an output electrical signal, such as, for example, a voltage, in response to the received input optical signal. The amount or extent of the output electrical voltage or signal may be directly proportional to, or at least directly related to, the amount or extent of the input optical power or signal.

The photodetector is electrically coupled with, or otherwise in electrical communication with, the microcontroller through one or more lines, traces, or other electrical signal pathways 218. The photodetector may provide the output electrical signal representing the detected light to the microcontroller. In one or more embodiments of the invention, the output electrical signal may include a voltage that is directly related to the amount or power of light detected by the photodetector. However, the scope of the invention is not limited to this particular type of electrical signal.

The microcontroller may receive the output electrical signal. In one or more embodiments of the invention, the microcontroller may receive the electrical signal through detection of changes in a voltage differential across the resistor. As will be explained in further detail below, in one or more embodiments of the invention, the microcontroller may use such electrical signals received from the photodetector in order to control or otherwise adjust currents that are provided to the VCSEL, or other semiconductor laser, in order to attempt to maintain a constant optical power output and/or attempt to maintain a constant extinction ratio. Such adjustments may help to avoid changes in the optical power and/or extinction ratio that may tend to occur as the temperature changes and/or as the semiconductor laser degrades or changes over time.

For simplicity, and ease of description, the description and claims will often refer to the microcontroller using the electrical signal received that is received from the photodetector. In practice, the microcontroller may often use a digitally converted representation of the received voltage or other analog electrical signal. As used herein, the terms received electrical signal is intended to encompass the actual received electrical signal as well as such conversions and representations of the actual received electrical signal.

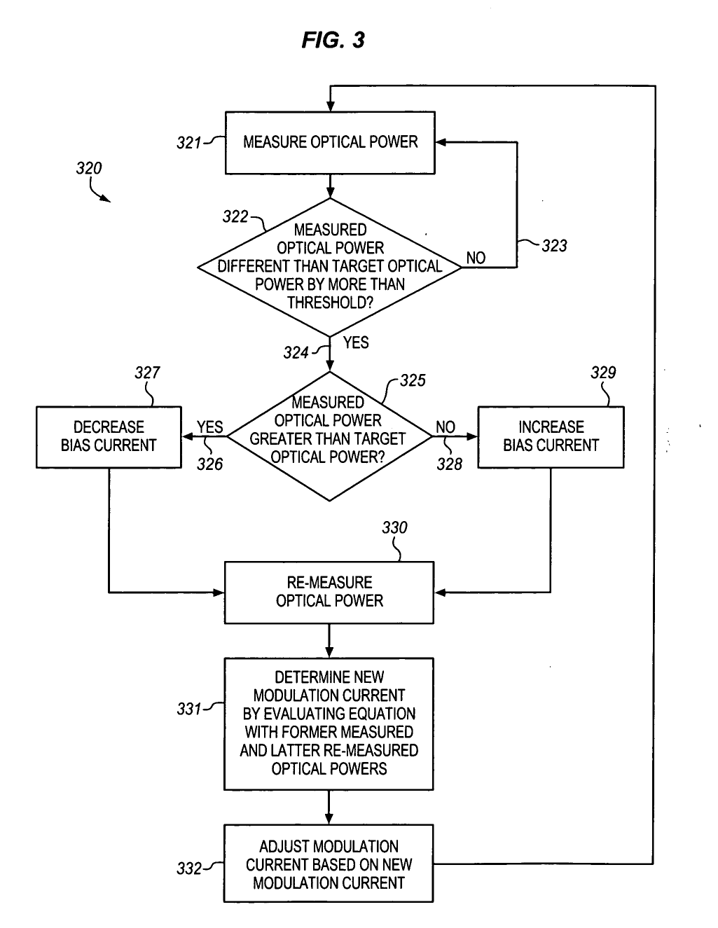

FIG. 3 is a block flow diagram of a method 320 of adjusting drive currents of a semiconductor laser in order to attempt to maintain a substantially constant optical power and a substantially constant extinction ratio, according to one or more embodiments of the invention. In one aspect, the method may be implemented by a photodetector and microcontroller in tandem in which the photodetector makes measurements and the microprocessor makes determinations based on the measurements, and adjustments based on the determinations. The operations performed by the microcontroller may be performed by software logic, such as, for example, executable instructions, or hardware logic, such as, for example, one or more circuits, or a combination of software and hardware logics (for example firmware that includes read-only memory having software stored thereon).

As used herein, the phrase “substantially constant extinction ratio”, and the like, mean that the extinction ratio changes by less than 20%. As used herein, the phrase “approximately constant extinction ratio”, and the like, means that the extinction ratio changes by less than 30%. As used herein, the phrase “substantially constant optical power”, and the like, means that the average optical power changes by less than 20%. As used herein, the phrase “approximately constant optical power”, and the like, means that the average optical power changes by less than 30%. The observed amount of variation in the optical power and extinction ratio may tend to depend, at least in part, on the target optical power and extinction ratio. In the event of significant deviation from a target optical power. of about 0.5 mW and extinction ratio of 4 (6 dB), different amounts of variation may be observed.

Initially, a photodetector may detect or measure a first optical power emitted by a VCSEL or other semiconductor laser, at block 321. In one or more embodiments of the invention, the photodetector may be included within the same TOSA as the laser. Alternatively, the photodetector may be otherwise proximate the laser, or otherwise configured to detect the optical power of the laser. The photodetector may provide a voltage or other electrical signal indicating the optical power to the microcontroller. The voltage may be directly proportional to, or at least directly related to, the optical power.

The microcontroller may receive the output voltage or other electrical signal from the photodetector. The microcontroller may include determination logic or a determination unit or module to make a first determination whether or not the measured optical power is different from a predetermined target optical power by more than a threshold, at block 322. For clarity, this threshold is not to be confused with the so-called threshold current shown and discussed in regard to FIG. 1. The threshold may be a constant value on the order of a fraction of the target optical power. Suitable thresholds include, but are not limited to, from about 1% to about 20% of the target optical output value, or from about 2% to about 10% of the target optical output value. These are just a few illustrative examples, and it should be appreciated that the scope of the invention is not limited to any known threshold value.

If the microcontroller determines that the values are different by less than the threshold, 323, (in other words if “no” is the determination), then the method may revisit block 321. In this way, when the measured and target optical powers are substantially similar, adjustment of electrical currents may be avoided. This may help to avoid making numerous adjustments, may help to avoid thrashing, and/or may help to dampen or stabilize control. However, the scope of the invention is not limited in this respect inasmuch as using a threshold is optional, not required.

Alternatively, if the microcontroller determines that the values are different by more than the threshold, 324, (in other words if “yes” is the determination), then the method may advance to block 325. At block 325, the microcontroller may include additional determination logic or unit or module to make a second determination. In particular, as shown in the illustrated embodiment, the microcontroller may determine whether or not the measured optical power is greater than the target optical power. It should be appreciated that this is just one of several possible roughly analogous determinations that may be made. For example, in an alternate embodiment of the invention, the microcontroller may determine whether or not the target optical power is greater than the measured optical power. In another alternate embodiment of the invention, the microcontroller may determine whether or not the measured optical power is less than or equal to the target optical power. These are just a few illustrative examples. In general, the microcontroller may compare the measured and target optical powers. Ratios and other forms of comparison are also potentially suitable.

The microcontroller may include adjustment logic or unit or module to adjust an electrical current, such as, for example, a bias current, that is provided to the semiconductor laser based, at least in part on, the aforementioned comparison of the measured first optical power and the predetermined target optical power. In particular, if, during this second determination, the microcontroller determines that the measured optical power is greater than the target optical power, 326, (in other words if “yes” is the determination), then the microcontroller may decrease the bias current, as shown at block 327. In one or more embodiments of the invention, the 6-bit current code may be decremented by one least significant bit, and then provided to the 6-bit DAC current source, such that the current source may provide a corresponding reduced current to the laser. Alternatively, decrements of the 6-bit DAC current source by two or more bits may be used. In one or more embodiments of the invention, the amount in which the bias current is decreased may be directly related to the extent of the difference between the measured and target optical powers.

Alternatively, if the microcontroller determines that the measured optical power is not greater than the target optical power, 328, (in other words if “no” is the determination), then the microcontroller may increase the bias current, as shown at block 329. Similarly as before, in one or more embodiments of the invention, the 6-bit current code may be incremented by one least significant bit, and then provided to the 6-bit DAC current source, such that the current source may provide a corresponding increased current to the laser.

Accordingly, the microcontroller may include negative feedback logic to adjust the bias current based on a measured optical power and a predetermined target optical power in order to attempt to reverse a direction of change of the optical power and maintain or control a constant optical power. Such adjustments may help to offset or avoid changes to the optical power when the temperature changes and/or when the transmit characteristics of the laser degrade or otherwise change over time. In one or more embodiments, the difference between the first measured optical power and the target optical power may be compared to a threshold and the electrical current may be adjusting only if the measured first optical power differs from the target optical power by more than the threshold. Such use of a threshold may help to avoid thrashing and may help to stabilize control, but is optional.

After decreasing the current at block 327, or increasing the current at block 329, the method may advance to block 330. At block 330, the photodetector may re-measure the optical power provided by the laser while it is operating at the adjusted current. That is, the photodetector may measure a second optical power emitted by the semiconductor laser while the laser operates at the previously adjusted current. As before, the photodetector may provide a voltage or other electrical signal indicating the re-measured optical power to the microcontroller.

The microcontroller may receive the output voltage or other electrical signal. As shown at block 331, the microcontroller may include additional determination logic or unit or module to determine a new electrical modulation current by evaluating an equation with the former measured optical power (which was measured at block 321) and the latter re-measured optical power (which was measured at block 330). As previously mentioned, either the actual received electrical signal may be used or a conversion or representation of the received electrical signal may be used. In one or more embodiments, the microcontroller may include an analog-to-digital converter to convert a received voltage into a digital number representing an amount of voltage or optical power. In one or more embodiments of the invention, the modulation current that is calculated may be capable of giving the semiconductor laser a substantially constant and/or approximately constant extinction ratio.

One example of a suitable equation, according to one or more embodiments of the invention, is the following Equation 1:

$${I}_{M} = \frac{{P}_{H} / {P}_{L} - 1}{{P}_{H} / {P}_{L} + 1} * \frac{{V}_{pd}}{Δ {V}_{pd}} \qquad ( 1 )$$

In this equation, Iₘ represents the new modulation current, P_{H} represents the high “on” optical power corresponding to a digital “1”, P_{L} represents the low “off” optical power corresponding to a digital “0”, Vpd represents the first optical power measured at block 321, and ΔV_{pd} represents the difference between the second optical power measured at block 330 and the first optical power measured at block 321.

A short derivation of Equation 1 may be helpful. The extinction ratio (ER) as a function of temperature (T) may be expressed by the following Equation 2 in units of decibels (dB):
ER(T)≡10*log(P_{H}/P_{L}) (2)

Above the threshold current (I_{T}), the average laser output power (LaserPower) increases approximately linearly with increasing applied average driver current (I) as expressed by the following Equation 3:
LaserPower≡S(T)*(I−I_{T}) (3)

Equations 2 and 3 may be re-written as the following Equation 4:

$$( \frac{{P}_{H}}{{P}_{L}} ) = ( \frac{S ( T ) * ( I - {I}_{T} + {I}_{M} )}{S ( T ) * ( I - {I}_{T} - {I}_{M} )} ) = ( \frac{( I - {I}_{T} ) + {I}_{M}}{( I - {I}_{T} ) - {I}_{M}} ) \qquad ( 4 )$$

The laser power is also related to average voltage from the photodetector (V_{PD}) and the change in voltage from the photodetector (ΔV_{PD}) when driver current to the semiconductor laser is increased by an amount corresponding to an increase in the digital signal from the microcontroller increasing by one least significant bit by the following Equation 5:

$$LaserPower = Constant ( T ) * \frac{{V}_{pd}}{Δ {V}_{pd}} \qquad ( 5 )$$

Where Constant(T) represents the change of average laser output power when the average driving current is increased according to the increase of the one least significant bit. Equations 4 and 5 may be combined and rearranged to give the following:

$$\begin{matrix}{I}_{M} = \frac{{P}_{H} / {P}_{L} - 1}{{P}_{H} / {P}_{L} + 1} * ( I - {I}_{T} ) \\ = \frac{{P}_{H} / {P}_{L} - 1}{{P}_{H} / {P}_{L} + 1} * \frac{{V}_{pd}}{Δ {V}_{pd}} * Constant ( T ) * / S ( T ) \\ = \frac{{P}_{H} / {P}_{L} - 1}{{P}_{H} / {P}_{L} + 1} * \frac{{V}_{pd}}{Δ {V}_{pd}}\end{matrix}$$

The equation immediately above gives Equation 1. Equation 1 may be used to calculate the modulation current to achieve a substantially or approximately constant extinction ratio in terms of a known ratio P_{H}/P_{L}, a measured voltage from the photodetector V_{PD}, and a change in the measured voltage from the photodetector (ΔV_{PD}) when the driver current is changed by the equivalent of one least significant bit of the digital driver signal.

The scope of the invention is not limited to using Equation 1. Rearrangements of Equation 1 are also suitable. Other variables or expressions may also or alternatively optionally be substituted into Equation 1 to give different equations. Further other equations entirely may be derived based on different models and/or assumptions of the behavior of the semiconductor laser. Examples include accounting for non-linearities, round-off, the non-zero portion below the threshold current, and the like. Accordingly, Equation 1 should be regarded as only one of many possible equations that may be used. Equation 1 has been provided to illustrate certain concepts, rather than to limit the scope of the invention.

If desired, the threshold current and slope efficiency may also optionally be calculated. One exemplary suitable equation for determining the threshold current is the following Equations 6:

$${I}_{T} = {I}_{B} - \frac{{V}_{pd}}{Δ {V}_{pd}} \qquad ( 6 )$$

In this equation, I_{T} represents the threshold current, and I_{B} represents the bias current.

One exemplary suitable equation for determining the slope efficiency is the following Equation 7:

$$S = \frac{LaserPower}{( {I}_{B} - {I}_{T} )} \qquad ( 7 )$$

In this equation, LaserPower represents the average output optical power, I_{B} represents the bias current, and I_{T} represents the threshold current. In one or more embodiments of the invention, the LaserPower may be determined from the measured voltage output of the photodetector by using calibration data that may be stored in the microcontroller, such as, for example, in EEPROM, and used to relate voltage to LaserPower in real time. Other equations, and other forms of the given equations, may also optionally be used. Additionally, calculating the threshold current and/or slope efficiency are optional, not required.

Threshold current and slope efficiency are commonly used by those skilled in the arts to characterize the behavior of semiconductor lasers. In one or more embodiments of the invention, during manufacture of an optical transceiver, one or more initial or starting slope efficiencies and thresholds at one or more temperatures (for example at room temperature) may optionally be determined and optionally stored in a non-volatile local memory of the optical transceiver, such as, for example, an EEPROM. The initial or starting slope efficiencies and thresholds may be used as benchmarks or standards by which to access change in optical performance of the optical transceiver. During runtime, slope efficiency and threshold current may be calculated as described elsewhere herein using firmware and optionally stored in a volatile local memory of the optical transceiver, such as, for example, a random access memory (RAM) of the microcontroller. The runtime calculated slope efficiency and threshold current may optionally be calculated frequently during operation, such as, for example, at least several times a minute, or even multiple times a second. In one or more embodiments of the invention, the calculated threshold current and/or slope efficiency and the initial slope efficiency and/or threshold current may be compared in order to access change to the optical transceiver, such as, for example, due to age or degradation. By way of example, the initial values in the EEPROM and the runtime calculated values in the RAM may be provided to a host system an I²C (Inter-IC) or other interface in order to allow the host system to monitor performance of the laser or optical transceiver. In one or more embodiments of the invention, a method may include determining to replace a module having a laser whose slope efficiency and/or threshold current has changed relative to the initial slope efficiency and/or threshold at the same temperature, which may potentially tend to indicate that the laser has aged, degraded, or otherwise changed.

Referring again to FIG. 3, as shown at block 332, the microcontroller may then adjust the modulation current based on the new modulation current. In one or more embodiments of the invention, the modulation current may be adjusted to the new modulation current. Alternatively, the modulation current may be adjusted partially toward the new modulation current, if desired.

As shown by the arrowed line connecting block 332 back to block 321, the method may optionally be repeated one or more or an arbitrarily large number of times. In various embodiments of the invention, the method may be implemented continually and/or periodically during operation of the optical transmitter. Representatively, the method may be performed once a minute, several times a minute, once a second, or multiple times a second, to name just a few examples. Performing the method less frequently is also suitable, although this may potentially result in significant changes in optical power and/or extinction ratio, especially when the temperature changes quickly as may occur, for example, during startup.

Optical transceivers using semiconductor lasers, such as, for example VCSELs, are currently available in a wide variety of form factors, each addressing a range of link parameters and protocols. These form factors are the result of Multi-Source Agreements (MSAs) that define common mechanical dimensions and electrical interfaces. An early MSA was the 300-pin MSA, followed by XENPAK, X2/XPAK, and XFP. Each of the transceivers defined by the MSAs may offer advantages that fit the needs of various systems, supporting different protocols, fiber reaches, and/or power dissipation levels.

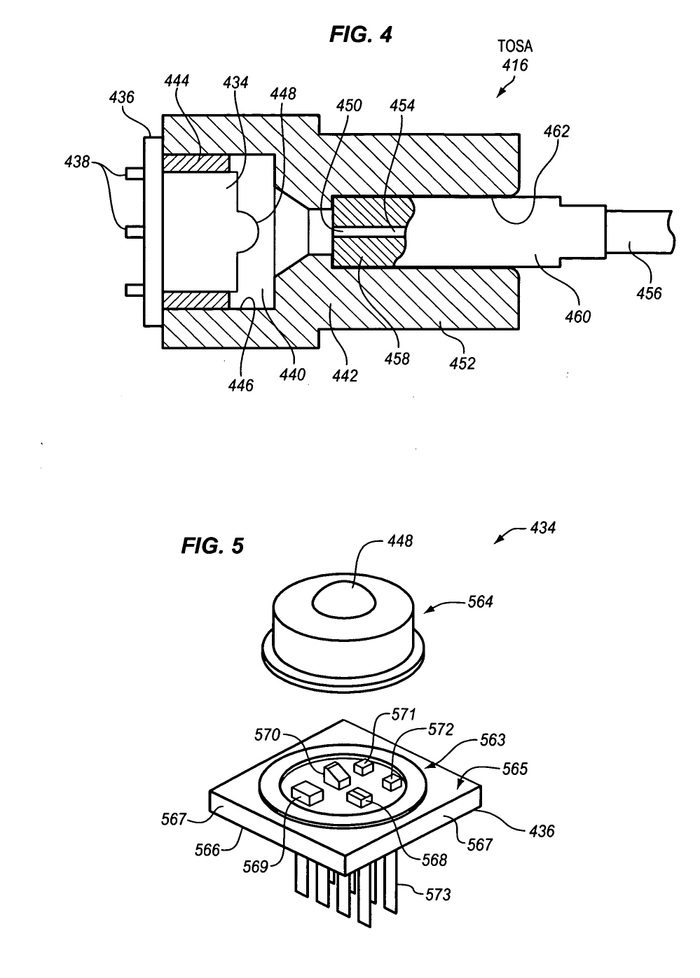

FIG. 4 is a sectional view of a transmitter optical sub-assembly (TOSA) 416 suitable for one or more embodiments of the invention. The illustrated TOSA 416 has a configuration known as a transistor-outline can (TO-can) package 434. This name refers to the shape of the TO-can that generally resembles the shape of a discrete transistor package. The TO-can may hermetically house sensitive components of the TOSA. The TO-can may include a header portion 436 having electrical leads 438. The TO-can may fit within a cavity 440 with the header portion abutting against an outer housing 442. A spacer 444 may be used to hold the TO-can against the inner walls 446 of the cavity. A lens or window 448 in the top of the TO-can may allow light to pass to or from an optical fiber core 450. The housing may be adapted to align the optical fiber core to the window of the TO-can. While the TO-can is shown as having a convex lens or window, the TO-can may alternatively comprise a metal can with a flat angled window. The housing may form the female portion 452 of a small form factor (SFF) pluggable connector, such as an LC connector, or other standardized removable connector for optical transceivers. The fiber 454 may have an extending cord section 456 and may further include an outer protective sheathing 458 that may be held by a mating portion of the connector comprising a ferrule 460 centering the fiber. The ferrule may be plugged into a ferrule receptacle 462 formed in the housing such that the fiber may be optically aligned with the window of the TO-can.

FIG. 5 is a perspective view showing the TO-can 434 for housing an optoelectronic assembly. The TO-can may include insulating base or header 436, a metal sealing member 563, and a metal cover 564. The header 436 may be formed of a material with good thermal conductivity to conduct heat away from the optoelectronic assembly. By using a high thermal conductivity material, the header may effectively dissipate the heat of un-cooled active optical devices, such as, for example, diode lasers, and can-incorporate integrated circuits, such as, for example, diode driver circuits or chips.

The insulating header may include an upper surface 565, a lower surface 566, and four substantially flat sidewalls 567 (two of which are shown) extending downwardly from the upper surface. The thickness of the header may be approximately 1 millimeter (mm). Alternatively, the insulating header may be thicker or thinner, as desired. The header may be configured as a multilayer substrate having a plurality of levels. Multiple metal layers may be provided at each of the plurality of levels, and laminated or otherwise joined together.

Various devices may be housed within the TO-can. For example, an active optical device 568, such as, for example, a VCSEL, and its associated integrated circuitry 569, other optical devices 570, such as, for example, a photodiode, and various other electrical components 571 and 572 may be located within an inner region of the metal sealing member.

At least one electrical lead 573 may be included and coupled to communicate signals from the optoelectronic and/or electrical components housed inside the package TO-can to components located external to the TO-can, such as, for example, on a printed circuit board, or other external signaling medium. The leads may be circular or rectangular in cross-section, as shown. Alternatively, the header may optionally be coupled with a printed circuit board or other signaling medium by using solder connections, such as, for example, ball grid array connections and/or a flex circuit.

The cover, which may include KovarT™ or another suitable metal, may be hermetically sealed to the metal sealing member in order to contain and fully enclose the optoelectronic and electrical components mounted to the upper surface of the header, and to thereby seal off the TO-can. Use of such a hermetically sealed cover may help to keep out moisture and ambient air, and reduce corrosion in order to protect the optoelectronic and electrical components therein.

The cover may include the transparent portion, such as, for example, a flat glass window, ball lens, aspherical lens, or GRIN lens, to name just a few examples. The optoelectronic components, such as, for example, the VCSEL, may be positioned within the TO-can such that light is able to pass to or from them through the transparent portion 214. In aspects, the transparent portion may be formed of glass, ceramic, plastic, or a combination. To avoid effecting the optoelectronic and electrical components housed within the TO-can, the transparent portion of the cover may optionally be provided with an antireflection coating to reduce optical loss and back-reflection.

In one or more embodiments of the invention, the TOSA 416 illustrated in FIGS. 4-5, or one like it, may be used for the TOSA 216 shown in FIG. 2. Alternatively, other types of TOSAs conforming to other MSAs may optionally be used. The scope of the invention is not limited to any particular TOSA, MSA, or form factor.

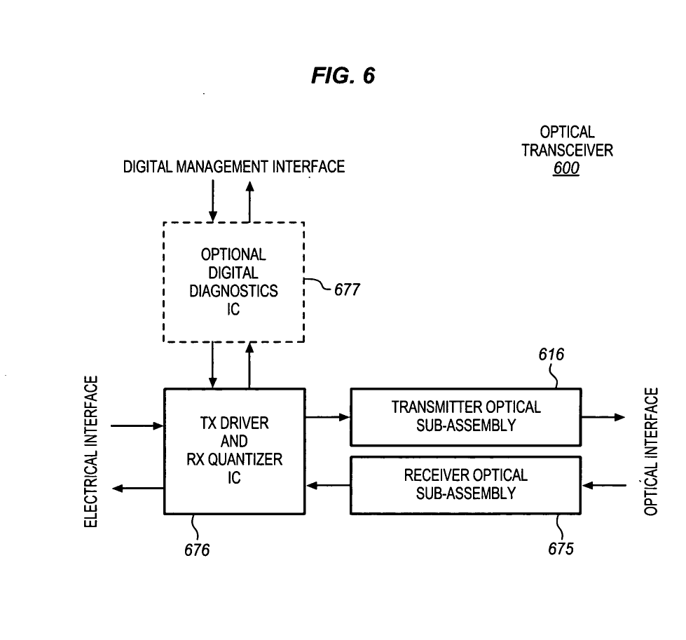

FIG. 6 is a block diagram of an optical transceiver 600 suitable for one or more embodiments of the invention. The optical transceiver includes a transmitter optical sub-assembly (TOSA) 616, a receiver optical sub-assembly (ROSA) 675, a transmitter (Tx) driver and receiver (Rx) quantizer integrated circuit (IC) 676, and an optional digital diagnostics IC 677. The TOSA and ROSA are electrically coupled with the Tx driver and Rx quantizer IC. The Tx driver and Rx quantizer IC is electrically coupled with the optional digital diagnostics IC. The TOSA and ROSA are capable of being coupled with an optical interface, such as, for example, one or more optical fibers. The Tx driver and Rx quantizer IC is capable of being coupled with an electrical interface, such as, for example, a high speed serial data bus. The optional digital diagnostics IC is capable of being electrically coupled with a digital management interface. The optional digital diagnostics IC may optionally be included to provide remote link monitoring capability. The digital diagnostics IC is considered optional, since some or all of the digital diagnostic functions may also optionally be implemented within a microcontroller as described elsewhere herein.

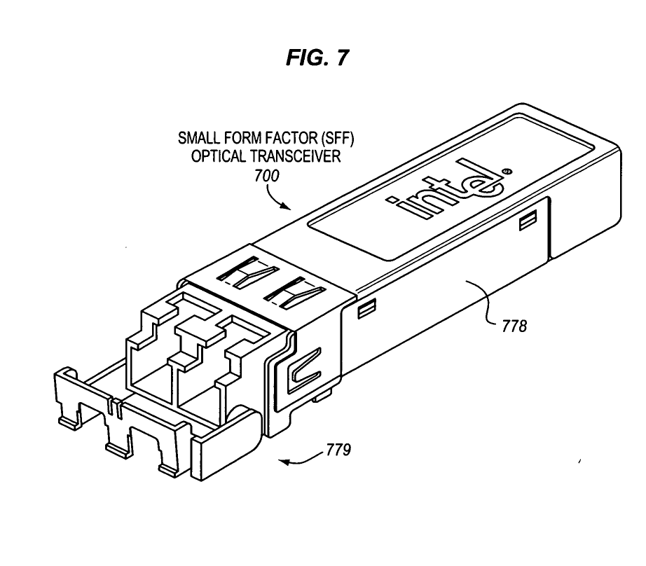

FIG. 7 is a perspective view of an exemplary Small Form Factor (SFF) optical transceiver package 700 suitable for one or more embodiments of the invention. As shown, the package may include a body 778 to housing electronic and optoelectronic components. Pins or other electrical connectors (not shown, but located on the bottom) may be provided on the body to couple with a circuit board or other signaling medium. The front of the package may include a receptacle portion 779 that is capable of receiving a mating plug in order to allow optical fibers or waveguides to communicate with the transceiver package. In the illustrated embodiment two receptacles are included, such as, for example, one for a transmitter receptacle and another for a receiver receptacle.

One illustrative SFF optical transceiver having certain features similar to the optical transceiver shown in FIG. 7 is the Intel® TXN31115 4/2/1 Gbps Small Form Factor Pluggable (SFP) Optical Transceiver, which is commercially available from Intel Corporation, of Santa Clara, Calif. The TXN31115 optical transceivers are Multi-Source Agreement (MSA) compliant and may provide high performance integrated duplex data links for bi-directional communication over multimode optical fiber. The modules may be designed for high-speed Fibre Channel data links at 4.25 Gbps (4× Fibre Channel rate). With the rate select feature, the module may be rate agile: and may also work at the 1× and 2× Fibre Channel rates (1.0625 Gbps and 2.125 Gbps) and the Gigabit Ethernet rate (1.25 Gbps). The Intel TXN31115 optical transceiver may be provided with an LC receptacle compatible with the industry standard LC optical connector. The SFF 850 nm transceivers may use a single 3.3V supply. The opto-electronic transceiver module may be a class-1 laser product that may be compliant with FDA Radiation Performance Standards, 21 CFR Subchapter J. The device may also be class 1 laser compliant according to International Safety Standard IEC-825-1. Other potential features may include compliant with fibre channel FC-PI standard, compliant with Ethernet 802.3z standard, compliant with SFP MSA, hot pluggable, bale latch design, 850 nm VCSEL emitter, 4.25/2.125/1.0625 Gbps fibre channel performance, 1.25 Gbps gigabit Ethernet performance, rate select for 4/2 Gbps or 2/1 Gbps, 2/1 Gbps only version also available, TTL signal detect output, transmitter disable input, 50 W AC-coupled CML level inputs/outputs, single +3.3V power supply, class 1 laser safety compliant, and UL 1950 approved. Further details, if desired, of similar suitable optical transceivers, is available in the Intel TXN31111 Tri-rate 850 nm SFP Optical Transceiver datasheet, Order No. 280049, Revision 004, published Jan. 14, 2005. In various other embodiments of the invention, optical transceivers having subsets of these features, supersets of these features, and other features entirely, are also suitable.

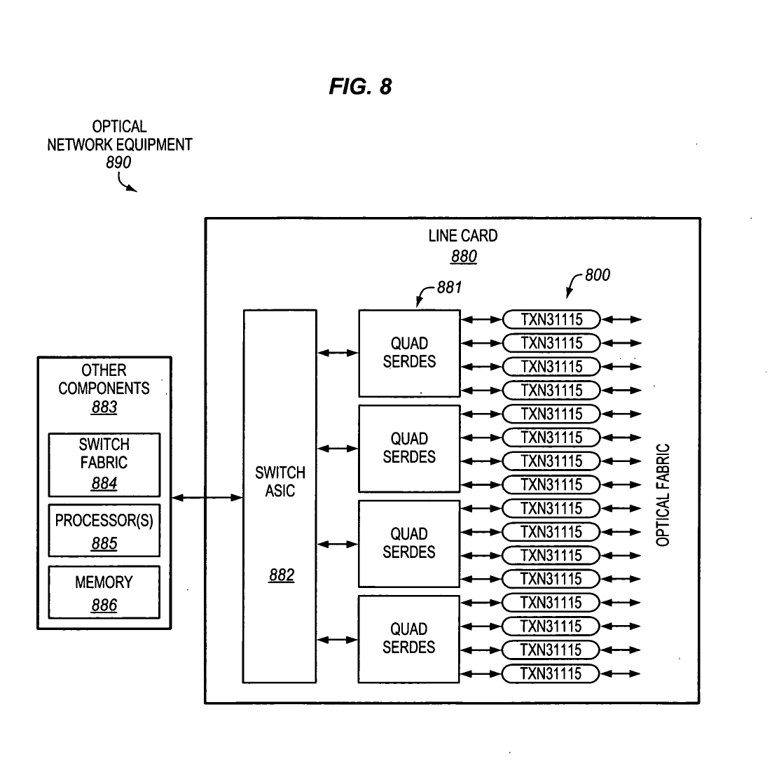

FIG. 8 is a block diagram of optical network equipment 890, according to one or more embodiments of the invention. The optical network equipment may include may include an optical switch or an optical router to name just a few examples.

The optical network equipment includes a line card 880 and other components 883. The line card includes multiple optical transceivers 800, such as, for example, Intel® TXN31115 optical transceivers, or other SFF optical transceivers, coupled therewith. In the illustrated embodiment, sixteen optical transceivers are coupled with the line card. The SFF modules, for example, allow for high module densities on the line card. Four optical transceivers are individually coupled to each quad SERDES 881. SERDES stands for serializer and de-serializer. The serializer part may take lower speed parallel data stream and serialize it to a higher speed data stream, and the de-serializer may take a higher speed serial stream and de-serialize it to a lower speed parallel data stream. Each quad SERDES may take four high-speed serial inputs and outputs. Four quad SERDES are each individually coupled with a switch application specific integrated circuit (ASIC) 882. The switch ASIC is capable of being coupled with a switch backplane or switch fabric.

As shown in the illustrated embodiment, the other components 883 may include conventional components, such as, for example, switch fabric 884, one or more processors 885, and memory 886. The term switch fabric generally refers to he internal interconnect architecture used by a switch to redirect data coming in on one of its ports out to another of its ports. In various embodiments of the invention, the processor may include a single processor core or multiple processor cores. In one or more embodiments of the invention, the memory may include dynamic random access memory (DRAM). DRAM is a type of memory used in some, but not all, network equipment.

In this description and in the claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate, interact, or communicate with each other.

As used herein, unless stated otherwise, operations such as determining, comparing, adjusting, calculating, computing, and the like, refer to operations performed by a device, such as, for example, a microcontroller, integrated circuit, other circuit, or optical transceiver, network equipment, or other device incorporating such a circuit. Such operations may include manipulating or transforming electrical signals and/or data stored in a memory for example.

In the description above, for the purposes of explanation, numerous specific, details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description.

It will also be appreciated, by one skilled in the art, that modifications may be made to the embodiments disclosed herein, such as, for example, to the sizes, configurations, functions, materials, and manner of operation of the components of the embodiments. All equivalent relationships to those illustrated in the drawings and described in the specification are encompassed within embodiments of the invention.

Various operations and methods have been described. Some of the methods have been described in a basic form, but operations may optionally be added to and/or removed from the methods. The operations of the methods may also often optionally be performed in different order. Many modifications and adaptations may be made to the methods and are contemplated.

Certain operations may be performed by hardware components, or may be embodied in machine-executable instructions, that may be used to cause, or at least result in, a circuit programmed with the instructions performing the operations. The circuit may include a general-purpose or special-purpose processor, or logic circuit, to name just a few examples. The operations may also optionally be performed by a combination of hardware and software.

One or more embodiments of the invention may be provided as a program product or other article of manufacture that may include a machine-accessible and/or readable medium having stored thereon one or more instructions and/or data structures. The medium may provide instructions, which, if executed by a machine, may result in and/or cause the machine to perform one or more of the operations or methods disclosed herein. Suitable machines include, but are not limited to, microconrollers, controllers, microprocessors, optical transmitters, optical transceivers, line cards, network devices, computer systems, and a wide variety of other devices with one or more processors, to name just a few examples.

The medium may include, a mechanism that provides, for example stores, information in a form that is accessible by the machine. For example, the medium may optionally include recordable and/or non-recordable mediums, such as, for example, floppy diskette, optical storage medium, optical disk, CD-ROM, magnetic disk, magneto-optical disk, read only memory (ROM), programmable ROM (PROM), erasable-and-programmable ROM (EPROM), electrically-erasable-and-programmable ROM (EEPROM), random access memory (RAM), static-RAM (SRAM), dynamic-RAM (DRAM), Flash memory, and combinations thereof.

For clarity, in the claims, any element that does not explicitly state “means for” performing a specified function, or “step for” performing a specified function, is not to be interpreted as a “means” or “step” clause as specified in 35 U.S.C. Section 112, Paragraph 6. In particular, any potential use of “step of” in the claims herein is not intended to invoke the provisions of 35 U.S.C. Section 112, Paragraph 6.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

Accordingly, while the invention has been thoroughly described in terms of several embodiments, those skilled in the art will recognize that the invention is not limited to the particular embodiments described, but may be practiced with modification and alteration within the spirit and scope of the appended claims. The description is thus to be regarded as illustrative instead of limiting.

What is claimed is:

1. A method comprising:
measuring a first optical power emitted by a semiconductor laser;
adjusting an electrical current that is provided to the semiconductor laser based at least in part on a comparison of the measured first optical power and a predetermined target optical power;
after said adjusting, measuring a second optical power emitted by the semiconductor laser;
determining an electrical current that is capable of giving the semiconductor laser a substantially constant extinction ratio by evaluating an equation with the first and second optical powers.

2. The method of claim 1, wherein said adjusting comprises adjusting the electrical current if the measured first optical power differs from the predetermined target optical power by more than a threshold.

3. The method of claim 2, wherein said adjusting comprises adjusting a bias current including:
decreasing the bias current if the measured first optical power is greater than the predetermined target optical power by more than the threshold; or
increasing the bias current if the measured first optical power is less than the predetermined target optical power by more than the threshold.

4. The method of claim 3, wherein the threshold ranges from 1% to 20% of the target optical power.

5. The method of claim 1, wherein said determining comprises determining a modulation current.

6. The method of claim 1, further comprising:
determining one or more of a slope efficiency and a threshold current by evaluating one or more equations; and
providing said one or more of the slope efficiency and the threshold current to a host system to allow the host system to monitor degradation of the laser.

7. An apparatus comprising:
a controller to provide control signals;
a variable current source electrically coupled with the controller to provide electrical current based on the control signals;
a semiconductor laser electrically coupled with the variable current source to emit light based on the electrical current;
a photodetector optically coupled with the semiconductor laser to measure the light, and electrically coupled with the controller to provide signals representing the measured light;
logic to cause the controller to adjust an electrical current provided by the variable current source based at least in part on a comparison of a first measured optical power and a predetermined target optical power, and
logic to cause the controller to determine an electrical current capable of achieving a substantially constant extinction ratio by evaluating an equation with the first measured optical power and a second optical power measured after the controller adjusts the electrical current.

8. The apparatus of claim 7, wherein the logic is to cause the controller to adjust the electrical current if the first measured optical power differs from the predetermined target optical power by more than a threshold.

9. The apparatus of claim 8, wherein the adjusted electrical current comprises a bias current, and wherein the logic is to cause the controller to adjust the bias current by:
decreasing the bias current if the first measured optical power is greater than the predetermined target optical power by more than a threshold; or
increasing the bias current if the first measured optical power is less than the predetermined target optical power by more than the threshold.

10. The apparatus of claim 9, wherein the threshold ranges from 1% to 20% of the target optical power.

11. The apparatus of claim 7, wherein the logic is to cause the controller to determine a modulation current by evaluating the equation.

12. The apparatus of claim 7, wherein the semiconductor laser and the photodetector are included in a transmitter optical sub-assembly (TOSA), and further comprising a small form factor (SFF) module housing the TOSA.

13. An article of manufacture comprising:
a machine-accessible medium that provides instructions that if executed result in a machine performing operations including,
adjusting an electrical current that is provided to a semiconductor laser based at least in part on a comparison of a first measured optical power of light emitted by the semiconductor laser and a predetermined target optical power; and
determining an electrical current that is capable of giving the semiconductor laser a substantially constant extinction ratio by evaluating an equation with the first measured optical power and a second optical power measured after the controller adjusts the electrical current.

14. The article of manufacture of claim 13, wherein the machine-accessible medium further provides instructions that if executed result in the machine performing operations including,
adjusting the electrical current if the first measured optical power differs from the predetermined target optical power by more than a threshold.

15. The article of manufacture of claim 13, wherein the machine-accessible medium further provides instructions that if executed result in the machine performing operations including,
adjusting a bias current by:
decreasing the bias current if the first measured optical power is greater than the predetermined target optical power by more than a threshold; or
increasing the bias current if the first measured optical power is less than the predetermined target optical power by more than a threshold.

16. The article of manufacture of claim 13, wherein the machine-accessible medium further provides instructions that if executed result in the machine performing operations including,
determining one or more selected from a slope efficiency and a threshold current; and
storing the one or more selected from the slope efficiency and a threshold current in a memory of a controller.

17. The article of manufacture of claim 13, wherein the machine-accessible medium further provides instructions that if executed result in the machine performing operations including,
determining a modulation current by evaluating the equation.

18. A system comprising:
switch fabric; and
at least one optical transceiver electrically coupled with the switch fabric, each of the at least one optical transceivers including:
a controller to provide control signals;
a variable current source electrically coupled with the controller to provide electrical current based on the control signals;
a semiconductor laser electrically coupled with the variable current source to emit light based on the electrical current; and
a photodetector optically coupled with the semiconductor laser to measure the light, and electrically coupled with the controller to provide signals representing the measured light;
logic to cause the controller to adjust an electrical current provided by the variable current source based at least in part on a comparison of a first measured optical power and a predetermined target optical power, and
logic to cause the controller to determine an electrical current capable of achieving a substantially constant extinction ratio by evaluating an equation with the first measured optical power and a second optical power measured after the controller adjusts the electrical current.

19. The system of claim 18, wherein the logic is to cause the controller to adjust the electrical current if the first measured optical power differs from the predetermined target optical power by more than a threshold.

20. The system of claim 18, wherein the adjusted electrical current comprises a bias current, and wherein the determined electrical current comprises a modulation current.
